(19) United States
(12) Patent Application Publication
(10) Pub. No.: US 2003/0051887 A1
(43) Pub. Date: Mar. 20, 2003

(54) Fire safety system

(76) Inventor: Frank B. Cramer, Mission Hills, CA (US)

Correspondence Address: Lowell Anderson, Stetina Brunda Garred & Brucker, Suite 250, 75 Enterprise, Aliso Viejo, CA, 92656, US

(21) Appl. No.: 09/954,488

(22) Filed: Sep. 17, 2001

(51) Int. Cl. A62C 3/07; A62C 2/00; A62C 8/00

(52) U.S. Cl. 169/62; 169/46; 169/49; 169/48

(57) ABSTRACT

A fire control system is provided that uses combusted gases from a turbine engine to fill the ullage of an airplane fuel tank. The combusted gases contain insufficient oxygen to support combustion. Before the combusted gases are provided to the ullage, the temperature is lowered and moisture is removed from the gases by one or both of a desiccant chamber that absorbs the moisture and a condenser chamber that freezes out the moisture. Hot combusted gases from the engine are periodically passed through the desiccant chamber and condenser chamber to remove the moisture and regenerate those chambers. Pairs of chambers are preferably provided so that timer controlled valves channel the combusted gases through one set of a condenser chamber and a desiccant chamber while another set of chambers is being regenerated.

### FIELD OF THE INVENTION

This invention relates to fire safety systems that suppress fire initiation and inhibit propagation of combustion in vehicles that use turbine engines, and especially in airplanes engines.

### BACKGROUND OF THE INVENTION

Many vehicles use internal combustion engines to operate, whether the engines are piston, rotary or turbine engines. All of these vehicles require highly combustible fuel in the form of gasoline, kerosene, fuel oil, petroleum products or other combustible fuels, and those fuels present a safety hazard. The fuel is often contained in a fuel tank which contains a large amount of air as the tank empties. Evaporation of the fuel into the fuel tank ullage presents a large air to fuel ratio that enhances the possibility of combustion. The risk of explosion in airplane fuel tanks is sufficient that the FAA has requested the American based airlines to resolve this problem. But the airlines have reportedly claimed that it is too expensive, apparently in part because of the complexities in carrying enough moisture-free, inert gas, like nitrogen, to replace the air in the fuel tanks.

One way of reducing the risk of fire arising in these movable fuel storage tanks is described in U.S. Pat. No. 6,012,533. Combusted gases from an airplane's turbine engine is extracted and ultimately added to the fuel tanks to prevent combustion because the exhaust has insufficient oxygen to permit combustion. But even with this improvement there are difficulties because the extracted exhaust may contain moisture in quantities sufficient to present problems. in the fuel storage, or in the operation of the engines.

Further, while the prior art describes using heat exchangers and desiccant chambers to remove moisture, the heat exchangers use separators that collect water that in turn requires disposal and the desiccant chambers are large and heavy in order to have the required capacity for moisture removal. There is thus a need for a light weight system suitable for use with aircraft that achieves a suitable level of moisture removal. The need for such light weight systems is especially present in aircraft applications and in military fighter aircraft which may change altitude frequently and thus encounter great temperature changes and greater moisture condensation problems. There is thus a need for a method and apparatus to reduce the risk of igniting the fuel in the fuel storage tanks while removing the moisture or controlling the moisture, and to do so economically and with a light weight system.

### SUMMARY OF THE INVENTION

This invention provides an inert gas to displace the air that would otherwise occupy the ullage in a fuel storage tank resulting in an environment that is not conducive to combustion as there is insufficient free oxygen to support combustion. Advantageously, the free oxygen (O₂) content is less than about 5%, and preferably below 1%. This inert gas advantageously comprises burnt gas in the form of gases from a previously combusted mixture that has been cooled to an appropriate temperature, that has the water removed, that has any sparks removed, and that is provided at a pressure suitable to the fuel storage tank. The burnt gas can be provided by taking a portion of the gases from the combustion can in the turbine engine associated with the fuel storage tank, or the burnt gas can be provided by the exhaust of a separate engine or even provided by a micro-combustor designed solely to provide burnt gas for the ullage of the fuel storage tanks.

Before the combusted gases are provided to the ullage of the fuel storage tanks, the temperature is lowered and moisture is removed from the gases by one or both of a desiccant chamber that absorbs the moisture and a condenser chamber that freezes out the moisture. Hot combusted gases from the engine are periodically passed through the desiccant chamber and condenser chamber to remove the moisture and regenerate those chambers. Pairs of chambers are preferably provided so that timer-controlled valves direct the combusted gases through one set of a condenser chamber and a desiccant chamber while another set of chambers is being regenerated. Thus, a first and second desiccant chamber can be used alternatively so that one desiccant chamber is being purged of moisture while the other chamber is absorbing moisture from the gases. Further, a first and second condenser can be used alternatively so that one condenser is being purged of moisture while the other condenser is condensing moisture from the gases.

Ambient air can be circulated through the condenser chamber to condense the moisture. But sufficiently cold ambient air may not be available until the aircraft has reached a sufficiently high altitude. Thus, the desiccant chamber can is also preferably placed in fluid communication with the condenser chamber to remove moisture during periods when the ambient air is not sufficiently cold to condense moisture from the gases passing through the condenser. In a further variation of this invention using a single desiccant chamber and a single condenser, with the desiccant chamber being regenerated when the condenser chamber is purged of moisture by passing the hot combustion gases through the desiccant chamber.

The present invention can also be viewed and described relative to the lines that carry the gases and the valves that control the flow of gases through those lines. Viewed in this manner, the invention provides a fire control system that uses an engine that burns fuel and generates at some location in the engine or exhaust, combustion gases having insufficient oxygen to support combustion of fuel vapors in airplane fuel tanks. A first line is placed in fluid communication with those combustion gases to transmit the combustion gases from the engine to a heat exchanger that reduces the temperature of the combustion gases.

A first and second condenser are selectively and alternately placed in fluid communication with the combustion gases from the heat exchanger. The condensers are also placed in fluid communication with ambient atmosphere to cool the combustion gasses sufficiently to precipitate moisture from the gases as the gases from the heat exchanger pass through the condenser.

A first valve is interposed between the heat exchanger and at least one of the first and second condensers and placed in fluid communication with the heat exchanger and the at least one of the first and second condensers. The first valve is configured to selectively and alternately place the at least one of the first and second condensers in fluid communication with combustion gases from the heat exchanger.

A second line is placed in fluid communication with the combustion gases at the engine and the first and second condensers to transmit hot combustion gases to the condensers to remove the moisture condensed by the condensers. A second valve is interposed between the engine and at least one of the first and second condensers. The second valve is also placed in fluid communication with the heat exchanger and the at least one of the first and second condensers. The second valve is configured to selectively and alternately place the at least one of the first and second condensers in fluid communication with the combustion gases from the heat exchanger.

An apparatus is thus advantageously provided for generating oxygen depleted gas for use in a fire control system for ullage in an airplane fuel tank. The apparatus includes an engine having at least one location that produces gases having insufficient oxygen to support further combustion. Because the engine is a turbine, the location is preferably a combustor of the turbine as the oxygen content is lowest at that location. At least one heat exchanger is placed in fluid communication with gases withdrawn from the location on the engine, in order to cool combusted gases withdrawn from that location. A first desiccant chamber is placed in fluid communication with the at least one heat exchanger to remove moisture from the combusted gases. A first valve is placed in fluid communication with the engine and the desiccant chamber to regulate the flow of hot gases from the engine through the desiccant chamber to remove the collected moisture from the desiccant chamber.

Preferably, but optionally, there is a first condenser in fluid communication with the heat exchanger and the first desiccant chamber to cool gases from the heat exchanger sufficiently to remove moisture. Advantageously the first condenser freezes the moisture or water vapor in the combusted gases. The first condenser is preferably placed in fluid communication with ambient air outside the airplane in order to cool the gases.

Preferably, but optionally, a second desiccant chamber in placed fluid communication with the heat exchanger to remove moisture from the combusted gases. The first valve is placed in fluid communication with the second desiccant chamber to regulate the flow of hot gases from the engine through the second desiccant chamber. There is preferably a second valve in fluid communication with the heat exchanger and at least one of the desiccant chambers. The first and second valves cooperate to direct gases from the heat exchanger through one of the desiccant chambers when the hot gas from the engine is directed through the other of the desiccant chambers. There is thus advantageously provided a means for regenerating one or more desiccant chambers to evaporate the moisture and regenerate the chamber.

Further, preferably, but optionally, a second condenser in placed in fluid communication with the heat exchanger and the second desiccant chamber to cool gases from the heat exchanger sufficiently to remove moisture. Moreover, there is preferably a valve in fluid communication with the heat exchanger and at least one of the condenser chambers, the various valves cooperating to direct gases from the heat exchanger through one of the condenser chambers when the hot gas from the engine is directed through the other of the condenser chambers. There is thus advantageously provided a means for regenerating one or more condenser chambers.

The desiccant chamber is placed in fluid communication with the ullage of an airplane fuel tank to provide the combusted gases to the ullage. Preferably, but optionally, the desiccant chamber is placed in fluid communication with a storage reservoir which in turn is in fluid communication with the ullage of an airplane fuel tank to provide the combusted gases to the ullage.

The first and second desiccant chambers, and the first and second condenser chambers can be used in various combinations with each other. Thus, the desiccant chamber(s) can be used alone, in combination with one or more desiccant chambers, or in combination with one or more condenser chambers. Less desirably, the condenser chambers can be used alone, but are preferably used in combination with one or more desiccant chambers. Advantageously, some of the desiccant and condenser chambers are regenerated by hot gases from the engine, while the remaining desiccant and condenser chambers are removing moisture from the combusted gases to ensure a continuous supply of gases to the ullage of the fuel tank.

This invention also comprises a method for providing gas for creating an inert atmosphere for use in the ullage of a fuel tank. The fuel tank is preferably an airplane fuel tank. The method comprises taking combusted gases from a engine, preferably a turbine engine, at a location where the gases have insufficient oxygen to support combustion, not just in the turbine, but in the fuel tank. Those combusted gases are passed through a first desiccant chamber to remove moisture from the gases. The desiccant chamber is regenerated by passing hot gases from the engine through the first desiccant chamber.

The method preferably, but optionally, further includes passing the combusted gases through at least one heat exchanger to lower the temperature of the combusted gases before passing the gases through the first desiccant chamber. The cooled, combusted gases from the desiccant chamber are passed to the ullage of a fuel tank. Preferably, the combusted gases are passed through a storage reservoir prior to passing the gases to the ullage. That storage reservoir allows more flexibility in the operation and regeneration of the desiccant chamber.

Preferably, the combusted gases pass through a second desiccant chamber to remove moisture from the gases while the first desiccant chamber is being regenerated. Further, the combusted gases preferably, but optionally pass through a first condenser to remove moisture from the combusted gases. The condensed moisture is removed from the first condenser by passing hot gases from the engine through the first condenser and venting the gas to the atmosphere. Preferably, but optionally, the combusted gases pass through a second condenser to remove moisture from the combusted gases while the moisture is being removed from the first condenser.

### BRIEF DESCRIPTION OF THE DRAWINGS

These, and other advantages of this invention will be more fully understood by reference to the following drawings and descriptions, in which like numbers refer to like parts throughout, and in which:

FIG. 1 is a schematic view of a system of this invention; and

FIG. 2 is a schematic view of a turbine engine of this invention.

### DETAILED DESCRIPTION OF THE PREFERRED EMBODIMENT

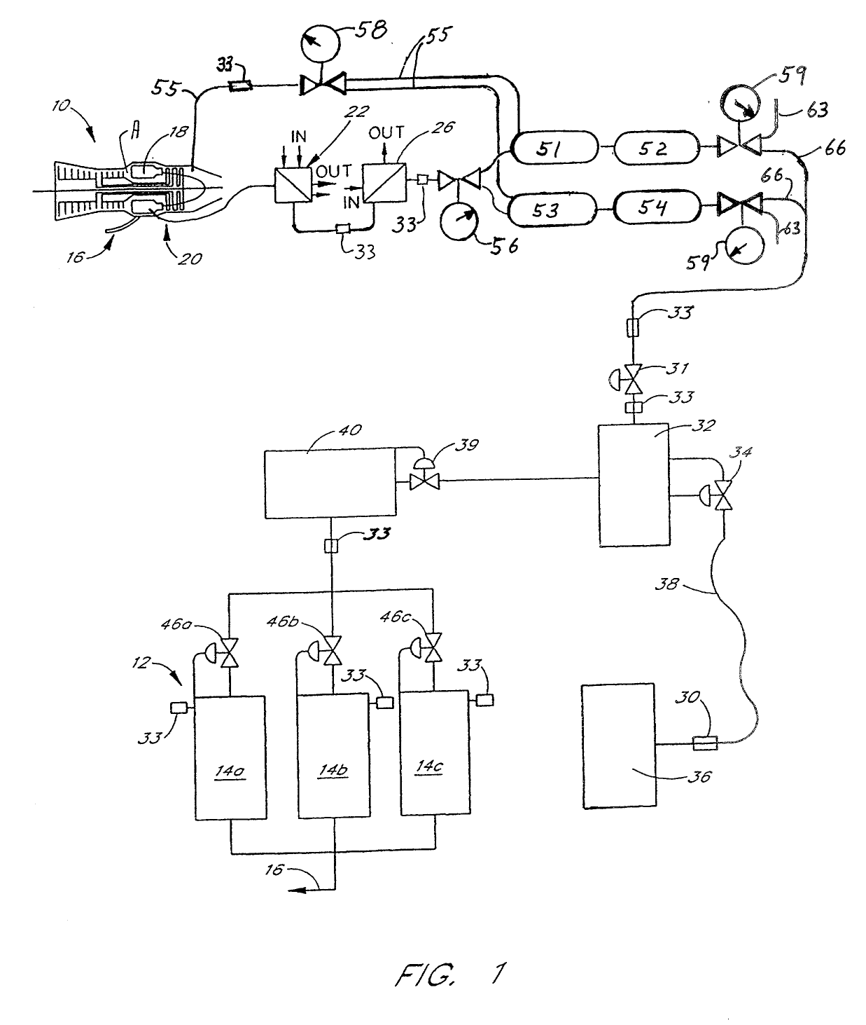

Referring to FIG. 1, a turbine engine 10 is provided with fuel from a fuel storage system 12 comprising one or more fuel tanks 14a, 14b etc., through fuel inlet line 16. Fuel is burned or combusted in one or more chambers, such as the combustors of the turbine. For ease of reference the discussion will refer to the engine 10 as a turbine with combustors 18.

A portion of the resulting combustion gases is withdrawn from the turbine 10 through first outlet line 20 at locations selected so that the withdrawn gases lack sufficient oxygen to support combustion. For turbine engines this location is preferably in the combustor 18, where the oxygen content is believed to be the lowest, but gases could be extracted further downstream depending on the needs of the particular application. A quarter inch diameter (6 mm) steel tube is believed sufficient to withdraw the combusted gases. For longevity and improved performance the line 20 may advantageously be cooled, for example, by air cooling or even by liquid cooling. The combustion gases are advantageously compressed well above atmospheric pressure and at, or near, the temperature of stoichiometric combustion when the source of the combustion gases comprises a turbine. The specific temperature, pressure and gas composition will vary with the source and particular operating conditions of the engines and the particular needs of the fuel tanks involved. For example, the gas composition at various locations of the engine 10 will vary depending on the weather, altitude, rate of acceleration or deceleration of the engine 10, type and quality of fuel. Other factors exist that affect the oxygen content of the fuel at various locations in the engine 10 and in its exhaust. Depending on the amount of oxygen permitted by the fuel ullage, the location of extraction can vary.

The outlet line 20 is in fluid communication with one or more heat exchangers 22a, 22b, that lower the temperature of the removed combustion gases. A quick disconnect 33 is advantageously, but optionally placed at various locations on the outlet line 20 relative to the heat exchanger to allow easy attachment and disconnection of the heat exchanger. A second heat exchanger 22b is used only as needed, and its design depends in large part upon the temperature of the exhaust gas from the engine 10, the extent to which the first heat exchanger 22a reduces the combusted gas temperature and the temperature at which the combusted gas must be provided to other components. Preferably the first heat exchanger 22a is on or in the engine 10 and removes about 80% of the heat. Thus, for example, exhaust gas at 2500° F. to 3000° F. (1400° C. to 1700° C.) will have its temperatures reduced to about 400° F. to 600° F. (250° C. to 350° C.). That initial temperature reduction makes it easier to move the combustion gases using less-insulated and lower temperature gas lines. The temperature of the combusted gases is preferably not lowered below the condensation temperature of the water vapor in the gas, as that would result in the moisture condensing in the gas line.

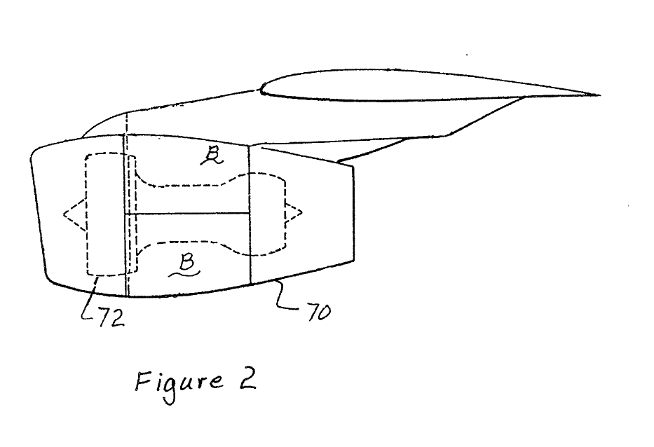

The heat exchangers 22 and 26 are preferably located in areas with high Reynolds numbers. Referring to FIG. 1, the first heat exchanger 22 is advantageously located so that it uses compressed air downstream of the large fans of the typical turbine engine and in front of the combustion can 18, as generally reflected by location A. This location provides a high flow, high Reynolds number, and lower temperature gases. Referring to FIG. 2, the second heat exchanger 26, if present, can advantageously be placed between the engine 10 and a cowling enclosing 70 the engine, and located downstream of the large fans 72 of the typical engine and before the exhaust. This location also has a high Reynolds number, and is reflected generally by the letter B in FIG. 2. The heat exchangers 22, 26 can be physically located in these locations, or be placed in fluid communication with compressed air from these locations.

Condenser 51 and associated desiccant chamber 52 are placed in fluid communication with the heat exchangers 22a, 22b, through the valve 56, to receive the cooled, combusted gas and to remove water from the gas. Preferably, condenser 53 and associated desiccant chamber 54 are also placed in fluid communication with the heat exchangers 22a, 22b, through the valve 56, to receive the cooled, combusted gas and to remove water from the gas. The desiccant chambers 52, 54 contain a renewable dehydrating agent. The valve 56 alternatively passes the combusted gasses through condenser 51 and desiccant chamber 52, or through condenser 53 and desiccant chamber 54. Preferably, the valve 56 has a timer so the flow path of the combusted gases alternates every 20-30 minutes. While one condenser and desiccant chamber are removing the water from the combusted gases, the other condenser and desiccant chamber are being regenerated by hot gases from the engine 10.

A second outlet line 55 is in fluid communication with the engine 10 and the condensers 51, 53, and desiccant chambers 52, 54, to provide hot gases to remove the moisture from those components and regenerate those components on an alternating basis, when those components are not being used to remove moisture from the combustion gases. The second line 55 preferably removes combusted gases from the engine 10, preferably from portions of the engine 10 downstream from the combustor 18 or elsewhere along the exhaust where hot gases are available. The second line 55 advantageously has a quick disconnect coupling 33 interposed between the engine 10 and a valve 58 which controls the location to which the gases from the second outlet line 55 are directed.

The valve 58 cooperates with the valve 56 to send the hot combustion gases from engine 10 to condenser 51 and desiccant chamber 52 to remove the moisture from those components, when valve 56 sends the oxygen-depleted gas to condenser 53 and desiccant chamber 54.. When valve 56 sends oxygen-depleted combusted gases to condenser 51 and desiccant chamber 52 for moisture removal, then valve 58 sends hot gases from engine 10 to the condenser 53 and desiccant chamber 54. The duty cycle in which gases are alternated to one or the other of the condensers and desiccant chambers will vary with the particular aircraft and design parameters, but a 20-30 minute duty cycle is believed desirable. If the time between regeneration is shorter, then the lifetime of the desiccant is shortened.

The condenser 51 advantageously comprises a container with a plurality of internal fins, made of high-heat conductive materials such as aluminum or copper. The condenser 51 can be actively chilled by an electrically powered refrigeration system that uses expanding gases such as Freon, to provide cooling. But that results in a heavy, more complex system with potential environmental consequences from the use of a refrigerant gas. Advantageously, the condensers 51 are in fluid communication with the atmosphere outside the airplane and use ambient air circulated through the condenser to chill the combusted gases passing through the condenser.

It is desirable to use this ambient air to have the condensers 51 take advantage of the relatively colder upper atmosphere temperature accessible to an aircraft during flight in order to “freeze out” the moisture remaining in the combusted gases. This can result in liquid collecting in the condensers 51 when the temperature is below the vaporization temperature of water for a given pressure and above the freezing temperature of water. But preferably the temperature is sufficient that moisture in the combusted gases freezes and precipitates in the condenser. That requires cooling the moisture in the combusted gases passing through the condenser 51 to a temperature below freezing. The freezing temperature is 32° F. or 0° C. at sea level, but because the aircraft operate at various altitudes, that freezing temperature will vary, as will the condensation or vaporization temperature.

The amount of water removed by the condensers 51 will vary according to the particular design. Water vapor will form and can condense below 212° F. or 100° C. at sea level, but the temperature will vary with the altitude of the airplane. If the temperature of the combusted gases from the heat exchanger(s) 22a, 22b are below the condensation temperature of water for the altitude of the airplane, then water will condense in one or more of the heat exchanger(s) 22a, 22b where the condensed water may be removed by separators known in the art. Preferably, the temperature of the gases is sufficiently high that the water will remain predominantly in the combustion gases and enter the condensers 51 for removal. It is believed desirable to have the temperature of the combustion gases lowered to about 35° F. to 65° F., and preferably about 55° F. to 65° F. by the time the combusted gases reach one or more condensers 51, located downstream of the engine 10.

From the desiccant chambers 52, 54, the combusted gases are directed either toward an exterior vent by vent line 63, or directed toward line 66 in fluid communication with a storage reservoir 32, by a valve 59 interposed between each desiccant chamber 52, 54 and storage reservoir 32. The valves 59 advantageously cooperate with valves 56, 58, to ensure the exhaust from the engine 10 that regenerates the desiccant chambers 52, 54 is vented to atmosphere, and that the combusted gases with moisture removed are directed toward storage tank 32. It is essential that the temperature of the gases entering the storage tank 32 be below the combustion temperature of the fuel being used by the airplane, and the use of freeze-out temperatures in condensers 51, 53 helps ensure that temperature is maintained.

A quick disconnect valve 33 is advantageously interposed between the line 66 and the storage tank 32. Such quick disconnect valves 33 may be used where deemed appropriate to allow ready separation of source of the inert combustion gas from distribution system, or to allow components such as desiccant chambers 52,54 and condenser chambers 51,53 to be readily removed and exchanged.

The condensers 51, 52 and desiccant chambers 52, 54 provide great flexibility to ensure that sufficient water is removed from the combustion gases in order to meet the performance criteria of a wide variety of applications. Further, the system could be further simplified by omitting the condenser chambers 52, 54. The use the renewable desiccant chambers 52, 54 to remove all the water from the combusted gases is believed usable. The life of the renewable desiccant may depend on the duty cycle during which the desiccant chambers 52, 54 must be dried out by the engine exhaust and regenerated.

In the embodiment of FIG. 1, the quick disconnect valve 33 is interposed between the desiccant chambers 52, 54 and storage reservoir 32, along with a pressure regulator valve (PRV) 31. The PRV 31 regulates the pressure of the combusted and de-moisturized gases to the main pressure reservoir 32 from the source of combusted gases, engine 10. The reservoir tank 32 is preferably, but optionally in fluid communication through another pressure regulator valve (PRV) 34 to a ground based source 36 of inert gas, through umbilical 38. The ground based source 36 also provides combusted gas at temperature lower than the combustion temperature and with moisture removed. The ground based source 36 provides gases to reservoir 32 while the engines of the plane are not operating and are thus incapable of providing the inlet combustion gases. When the airplane engines provide the requisite gases the ground based source 36 can be disconnected.

The main pressure reservoir 32 is advantageously maintained at pressures between two and ten atmospheres above ambient, although lower pressures may be suitable for fuel tanks that are not designed to be pressurized with inert gases. The volume and the pressure of the main reservoir 32 is such as to comfortably accommodate normal flow rates, any flow variations arising during recharging of condensers 51, 53 or desiccant chambers 52, 54, changes in flow rates and for the emergency use of inert gases to suppress flames or combustion in emergencies of line and/or equipment breaks with fuel discharges. Such design parameters will take into account historical records of accidents in these types of facilities. The reservoir 32 may be of aluminum alloy, stainless steel, plastic, or fiber glass composite. The particular material will be selected according to the demands of the particular application.

The reservoir 32 is also in fluid communication with one or more fuel tanks of the airplane, illustrated in FIG. 1 as tanks 14a-14c. As further illustrated in FIG. 1, reservoir tank 32 is preferably, but optionally in fluid communication with a secondary distribution tank 40, with a PRV 39 interposed between the reservoir tank 32 and secondary tank 40. The combusted gases are delivered through PRV 39 to distribution reservoir 40 which is maintained at a pressure only slightly greater than the fuel tanks 40 to which the inert combusted gas is to be delivered. The volume and pressure for the distribution reservoir 40 will be designed to accommodate the amount and range of flow rates expected from the assortment of recipient fuel tanks. The combusted gases fed to the tanks 14 should be below the temperature that would cause the fuel to exert excessive vapor pressure on the fuel tanks 14a-14c during operation, and the temperature of the combusted gas as it is provided to the ullage of the fuel tanks is ideally the same temperature as the fuel within those tanks. For practical purposes, the desired temperature of the combusted gases is ambient operating temperature of the fuel tank. For most applications, a temperature 20° C. is believed suitable.

The distribution tank 40 is in fluid communication with one or more airplane fuel tanks 14, with a PRV 46a-46c interposed between the secondary tank 40 and each individual fuel tank 14. The fuel tanks 14 are in turn are connected to the engine 10 to provide fuel to the engine. The inert combustion gases are fed to the fuel tanks 14 via PRV 46a-46c to develop a pressure in the ullage space of the tanks 14 on the order of 2% to 5% over the ambient pressure and preferably as close to ambient pressure as possible. Thus, the contents of these fuel tanks 14 are maintained continuously in a non-flammable/non-explosive state. When a tank 14 is being refilled, the surplus inert combustion gas in the reducing ullage space may be pumped back to either the main reservoir or the distribution tanks for reuse, or vented to atmosphere with appropriate safeguards for the vented gas.

Suitable temperature sensors, flow meters, flow control valves, pressure valves and pressure sensors are located between the engine 10 and the fuel tanks 14 to regulate the temperature, pressure and flow rate of the gas provided to the tanks 14. Thus, for example, suitable flow meters and pressure meters 35 will be interposed at suitable locations between the engine 10, the storage reservoir 32, secondary storage tank 40 and fuel tanks 14 to determine and control the amount of combusted gases provided to reservoirs and tanks 32, 40 and 14. Because the source of the combusted gas (engine 10) is typically above atmospheric pressure, only pressure reduction regulators are required, which eliminates the more complex equipment and methods needed to increase the pressure. Preferably, the pressure differential between storage tank 32 and fuel tank 14 controls the flow and thus flow meters are not needed.

The pressure is adjusted depending on the source of the combusted gas and the pressure desired for the fuel tanks 14, as well as any need to compensate for variable pressure as would be appropriate for airplanes that change pressure with the altitude. The above described embodiment is especially suitable for turbine engines used on airplanes, in part because of the relatively light weight possible with this regeneration system, and partially because of the moisture condensation associated with variations in altitude. But the same components can be used with other turbine powered vehicles and vessels, such as ships, vehicles, trains, tank trucks, air tankers, and or other applications where there is a large ullage in tanks containing flammable liquids, where it is advantageous to have the ullage filled with inert gas. This apparatus has special application in moveable things where removal of moisture from the fuel is desirable and a rechargeable mechanism for removing that moisture is advantageous.

The above description uses various valves to control the flow of gases from the engine 10 to the fuel tanks 14. Any number of valves could be used to achieve the various flows of gases and other fluids in this description, and the invention is not limited to the depicted components.

The above descriptions are for supplying inert combustion gas with controlled moisture to ullage in a fuel container to inhibit or combustion. The same method and apparatus could be used to supply inert combustion gases to suppress combustion when it is detected in undesirable locations, by merely providing a fluid communication from the reservoir 32 or tank 40 opening into such locations through suitable valves and controls. If an undesirable flame or combustion is detected then the inert gas can be channeled through the fluid communications to the location of the flame or combustion in order to deplete the oxygen and stop the combustion.

There is thus advantageously provided a method and apparatus for inhibiting combustion by providing an inert, previously combusted gas with controlled moisture, controlled temperature, and regulated amount of free, combustible oxygen. Advantageously the inert combustion gas is supplied to fuel tank ullage in airplanes. The inert gas may be applied to a variety of applications that have flammable liquid in a container, where it is advantageous to provide an inert gas with controlled moisture and temperature to the ullage in the container.

There is also advantageously provided a method for providing gas for creating an inert atmosphere in the ullage of an aircraft fuel tank by removing combusted gases from a turbine engine at a location where the gases have insufficient oxygen to support combustion. The method lowers the temperature of the combusted gas by a heat exchanger to a temperature above the condensation temperature of the water vapor in the combusted gas. Water vapor is removed by passing the combusted and cooled gas through at least one of a first desiccant chamber and a first condensation chamber. The combusted and cooled gas is passed to the ullage of the fuel tank. At least one of the desiccant chamber and condensation chamber is regenerated by passing hot gas from the engine through the chamber being regenerated. This method allows small, lightweight, components to be used.

The method also preferably includes removing water vapor by passing the combusted and cooled gas through a second desiccant chamber while the first desiccant chamber is being regenerated. Further, the method advantageously includes removing water vapor by passing the combusted and cooled gas through a second condensation chamber while the first condensation chamber is being regenerated. Moreover, the water vapor is advantageously removed by passing the combusted and cooled gas through the first condensation chamber which has temperature below the condensation temperature of the water vapor in the combusted gases. Preferably, the water vapor is removed by passing the combusted and cooled gas through the first condensation chamber which has a temperature below the freezing temperature of the water vapor in the combusted gases. Further, the first desiccant chamber in preferably placed series with the first condensation chamber and downstream from the first condensation chamber. Optionally, but less preferably, the first condensation chamber is placed in parallel with the first desiccant chamber. In this last option, a second desiccant chamber is preferably placed in series with the first condensation chamber, and a second condensation chamber is preferably placed in series with the first desiccant chamber.

The above described embodiments of the invention have been illustrated and described with reference to the accompanying drawings. The various components of this invention can be used alone, or in various combinations with each other. Thus, for example, the desiccant chambers can be located upstream of the condensation chambers, downstream of the condensation chambers, in series or in parallel with the condensation chambers. Those skilled in the art will understand that these preferred embodiments are given by way of example only. Various changes and modifications may be made without departing from the scope and spirit of the invention as defined in the following claims.

What is claimed is:

1. A fire control system for a fuel tank containing fuel and having ullage, comprising:
an engine that burns fuel and generates combustion gases, the engine having a location at which the gases have insufficient oxygen to support further combustion in the engine;
a first line in fluid communication with the combusted gases at the location to transmit the combusted gases from that location to a heat exchanger to reduce the temperature of the combustion gases;
a first and second desiccant chamber selectively and alternately placed in fluid communication with the combustion gases from the heat exchanger to remove moisture from the desiccant chambers and thereby regenerate the chambers;
a first valve in fluid communication with the heat exchanger and at least one of the first and second chambers, the first valve being configured to selectively and alternately place the at least one of the first and second chambers in fluid communication with the combustion gases from the heat exchanger;
a second line in fluid communication with the combustion gases at the engine and the first and second chambers to transmit hot combustion gases from the engine to the chambers;
a second valve in fluid communication with the engine and at least one of the first and second chambers, the first valve being configured to selectively and alternately place the at least one of the first and second chambers in fluid communication with the combustion gases from the heat exchanger, the first and second valves cooperating to alternately pass the hot gases from the engine and the combusted gases from the location on the engine through different ones of the chambers; and
a third valve in fluid communication with at least one of the chambers and with the ullage of the fuel storage tank, the third valve cooperating with the first and second valves to pass cooled gas from the chamber to the ullage.

2. The fire control system as defined in claim 1, further comprising a reservoir in fluid communication with the third valve and ullage so that cooled, combusted gases can be stored in the reservoir.

3. The fire control system as defined in claim 1, further comprising a condenser in fluid communication with one of the desiccant chambers, the condenser being placed in fluid communication with ambient atmosphere to cool the combustion gasses and remove moisture from the gases as the gases from the heat exchanger pass through the condenser.

4. The fire control system as defined in claim 3, wherein the condenser is further in fluid communication with the hot gases in the second line in order to remove moisture from the condenser.

5. The fire control system as defined in claim 1, wherein the engine comprises a turbine and the location comprises a combustor of the turbine.

6. An apparatus for generating oxygen depleted gas for use in a fire control system for ullage in an airplane fuel tank, comprising:
an engine having at least one location that produces gases having insufficient oxygen to support further combustion;
at least one heat exchanger in fluid communication with the at least one location to cool combusted gases withdrawn from that at least one location;
a first desiccant chamber in fluid communication with the at least one heat exchanger to remove moisture from the combusted gases; and
a first valve in fluid communication with the engine and the desiccant chamber to regulate the flow of hot gases from the engine through the desiccant chamber to remove moisture from the desiccant chamber.

7. The apparatus of claim 6, further comprising a first condenser in fluid communication with the heat exchanger and the first desiccant chamber to cool gases from the heat exchanger sufficiently to remove moisture.

8. The apparatus of claim 6, further comprising a second desiccant chamber in fluid communication with the heat exchanger to remove moisture from the combusted gases, the first valve being placed in fluid communication with the second desiccant chamber to regulate the flow of hot gases from the engine through the second desiccant chamber.

9. The apparatus of claim 8, further comprising a first condenser in fluid communication with the heat exchanger and the first desiccant chamber to cool gases from the heat exchanger sufficiently to remove moisture; and
a second condenser in fluid communication with the heat exchanger and the second desiccant chamber to cool gases from the heat exchanger sufficiently to remove moisture.

10. The apparatus of claim 7, wherein the first condenser is in fluid communication with ambient air to cool the gases.

11. The apparatus of claim 8, wherein the first condenser is in fluid communication with ambient air to cool the gases.

12. The apparatus of claim 9, wherein the first condenser is in fluid communication with ambient air to cool the gases.

13. The apparatus of claim 6, wherein the engine is a turbine engine.

14. The apparatus of claim 8, wherein the engine is a turbine engine and the at least one location is a combustor of the turbine.

15. The apparatus of claim 8, further comprising a second valve in fluid communication with the heat exchanger and at least one of the desiccant chambers, the first and second valves cooperating to direct gases from the heat exchanger through one of the desiccant chambers when the hot gas from the engine is directed through the other of the desiccant chambers.

16. The apparatus of claim 9, further comprising a second valve in fluid communication with the heat exchanger and at least one of the desiccant chambers, the first and second valves cooperating to direct gases from the heat exchanger through one of the desiccant chambers when the hot gas from the engine is directed through the other of the desiccant chambers.

17. The apparatus of claim 6, wherein the desiccant chamber is placed in fluid communication with the ullage of an airplane fuel tank.

18. The apparatus of claim 6, wherein the desiccant chamber is placed in fluid communication with the a storage reservoir which in turn is in fluid communication with the ullage of an airplane fuel tank to provide the combusted gases to the ullage.

19. The apparatus of claim 8, wherein the desiccant chamber is placed in fluid communication with the ullage of an airplane fuel tank.

20. The apparatus of claim 8, wherein the desiccant chamber is placed in fluid communication with the a storage reservoir which in turn is in fluid communication with the ullage of an airplane fuel tank to provide the combusted gases to the ullage.

21. The apparatus of claim 16, wherein the desiccant chamber is placed in fluid communication with the a storage reservoir which in turn is in fluid communication with the ullage of an airplane fuel tank to provide the combusted gases to the ullage.

22. A method for providing gas for creating an inert atmosphere in the ullage of an aircraft fuel tank, comprising:
taking combusted gases from a turbine engine at a location where the gases have insufficient oxygen to support combustion;
passing those combusted gases through a first desiccant chamber to remove moisture from the gases;
regenerating the desiccant chamber by passing hot gases from the engine through the first desiccant chamber.

23. The method of claim 22, further comprising passing the combusted gases through at least one heat exchanger to lower the temperature of the combusted gases before passing the gases through the first desiccant chamber and passing the combusted gases from the desiccant chamber to the ullage of a fuel tank.

24. The method of claim 23, further comprising passing the combusted gases through a storage reservoir prior to passing the gases to the ullage.

25. The method of claim 22, further comprising passing the combusted gases through a second desiccant chamber to remove moisture from the gases while the first desiccant chamber is being regenerated.

26. The method of claim 23, further comprising passing the combusted gases through a second desiccant chamber to remove moisture from the gases while the first desiccant chamber is being regenerated.

27. The method of claim 24, further comprising passing the combusted gases through a second desiccant chamber to remove moisture from the gases while the first desiccant chamber is being regenerated.

28. The method of claim 22, further comprising passing the combusted gases through a first condenser to remove moisture from the combusted gases, and removing condensed moisture from the first condenser by passing hot gases from the engine through the first condenser.

29. The method of claim 28, further comprising passing the combusted gases through a second condenser to remove moisture from the combusted gases while the moisture is being removed from the first condenser.

30. The method of claim 24, further comprising passing the combusted gases through a first condenser to remove moisture from the combusted gases, and removing condensed moisture from the first condenser by passing hot gases from the engine through the first condenser.

31. The method of claim 30, further comprising passing the combusted gases through a second condenser to remove moisture from the combusted gases while the moisture is being removed from the first condenser.

32. A method for providing gas for creating an inert atmosphere in the ullage of an aircraft fuel tank by removing combusted gases from a turbine engine at a location where the gases have insufficient oxygen to support combustion, comprising:
lowering the temperature of the combusted gas by a heat exchanger to a temperature above the condensation temperature of the water vapor in the combusted gas;
removing the water vapor by passing the combusted and cooled gas through at least one of a first desiccant chamber and a first condensation chamber;
passing the combusted and cooled gas to the ullage of the fuel tank; and
regenerating at least one of the desiccant chamber and condensation chamber by passing hot gas from the engine through the chamber being regenerated.

33. The method of claim 32, further comprising removing water vapor by passing the combusted and cooled gas through a second desiccant chamber while the first desiccant chamber is being regenerated.

34. The method of claim 32, further comprising removing water vapor by passing the combusted and cooled gas through a second condensation chamber while the first condensation chamber is being regenerated.

35. The method of claim 32, wherein the water vapor is removed by passing the combusted and cooled gas through the first condensation chamber which has a temperature below the condensation temperature of the water vapor in the combusted gases.

36. The method of claim 32, wherein the water vapor is removed by passing the combusted and cooled gas through the first condensation chamber which has a temperature below the freezing temperature of the water vapor in the combusted gases.

37. The method of claim 32, wherein the water vapor is removed by passing the combusted and cooled gas through the first condensation chamber which has a temperature below the freezing temperature of the water vapor in the combusted gases and placing the first desiccant chamber in series with the first condensation chamber and downstream from the first condensation chamber.

38. The method of claim 32, wherein the water vapor is removed by passing the combusted and cooled gas through the first desiccant chamber.

39. The method of claim 37, further comprising removing water vapor by passing the combusted and cooled gas through a second condensation chamber having a temperature below the freezing temperature of the water vapor in the combusted gases, while the first condensation chamber is being regenerated.

40. The method of claim 38, comprising placing the first condensation chamber in series with the first desiccant chamber.

41. The method of claim 38, comprising placing the first condensation chamber in parallel with the first desiccant chamber.
